(19) United States
(12) Patent Application Publication
(10) Pub. No.: US 2025/0386955 A1
(43) Pub. Date: Dec. 25, 2025

(54) INTELLIGENT MATTRESS SEAT AND CHILDREN'S PRODUCT

(71) Applicant: SUZHOU GOODBABY QINGTAO TECHNOLOGY SERVICE CO., LTD., Kunshan (CN)

(72) Inventors: Feng LIU, Kunshan (CN); Shaohai FANG, Kunshan (CN); Jinlong LIAN, Kunshan (CN)

(21) Appl. No.: 18/879,517

(22) PCT Filed: Jun. 30, 2023
(86) PCT No.: PCT/CN2023/104676

§ 371 Date: Dec. 27, 2024

(30) Foreign Application Priority Data
Dec. 29, 2022 (CN) 202211706510.1

(51) Int. Cl. A47D 15/00; A47D 7/01; G10L 25/63

(52) U.S. Cl. CPC A47D 15/001; A47D 7/01; G10L 25/63

(57) ABSTRACT

A mattress seat comprising a mattress seat body configured to receive a mattress thereon, the mattress seat body comprising a plurality of frames disposed sequentially in a circumferential direction of the mattress seat body, at least one of the plurality of frames is movable with respect to the other one of the plurality of frames in the circumferential direction of the mattress seat body to enable a length of the mattress seat body to be adjusted in at least one direction.

The present application claims priority to Chinese Patent Application No. CN2022117065101, entitled “INTELLIGENT MATTRESS SEAT”, filed on Dec. 29, 2022 before China National Intellectual Property Administration, the entire contents of which are incorporated herein by reference.

### TECHNICAL FIELD

The present disclosure relates to the field of children's products, and more particularly to an intelligent mattress seat and a children's product.

### BACKGROUND ART

Infant bed refers to a bed designed for infants and young children, and is generally used together with infant mattress. There are many styles of infant beds and mattresses on the market, but they generally have a single function without intelligent soothing function. It is often necessary to artificially soothe infants, especially young children, which often fatigues the child-rearing person. In addition, due to the rapid growth of infants and young children, existing infant beds are generally used for a short period of time, resulting in high cost of nurturing and waste of resources.

### SUMMARY OF THE INVENTION

It is an object of the present disclosure to provide an intelligent mattress seat and a children's product having the function of intelligently soothing an infant.

In order to achieve the above-mentioned object, the technical solution adopted by the present disclosure is as follows:

An intelligent mattress seat, including a mattress seat body, wherein the intelligent mattress seat further includes a lifting mechanism, a driving device and a control device, wherein the lifting mechanism is connected to the mattress seat body, the driving device is connected to the lifting mechanism, an output end of the control device is electrically connected to an input end of the driving device, the control device is configured to activate or inactivate the driving device, and, when the driving device is activated, the driving device is configured to drive the lifting mechanism to reciprocate upwardly and downwardly and/or swing. The lifting mechanism can drive a child-bearing apparatus, such as a mattress, a sleeping basket and a seat, which are provided above the lifting mechanism to move, so that the intelligent mattress seat at least has a soothing function for driving the child-bearing apparatus to lift and shake.

In some implementations, a length of the mattress seat body is adjustable in at least one direction. Further, the mattress seat body may be adjustable in length and/or width. Thus, a size of the mattress seat body can be adjusted, and with the growth of children, the intelligent mattress seat can adapt to mattress of different sizes, accommodate children of different body types or different ages, and extend a service life of the intelligent mattress seat.

In some implementations, a length of the lifting mechanism is adjustable in at least one direction. This makes it possible to better accommodate child-bearing apparatuses of different specifications that it is intended to carry.

In some implementations, the mattress seat body includes a plurality of frames, and the plurality of frames are disposed sequentially in a circumferential direction of the mattress seat body; and at least one of the plurality of frames is movable with respect to the other frames in the circumferential direction of the mattress seat body. This allows for adjustment of a size of a rack of the mattress seat body.

In some implementations, the mattress seat body further includes a connecting member, and at least two adjacent frames of the plurality of frames are provided with one connecting member in between, wherein at least one frame is slidably disposed with respect to the connecting member in the circumferential direction of the mattress seat body. The arrangement of the connecting members enhances the strength of the sliding connection between the different frames, facilitates the assembly of the rack, and provides space for the arrangement of a guiding mechanism, a locking mechanism, etc.

In some implementations, the mattress seat body further includes a plurality of connecting members, every adjacent two of the frames are connected to each other via one of the connecting members, and the plurality of frames and the plurality of connecting members together enclose a rack of the mattress seat body; at least two of the connecting members are adjustable, and each of the adjustable connecting members is slidably disposed with respect to at least one of the frames correspondingly connected thereto in the circumferential direction of the mattress seat body. Thus, the mattress seat body can be quickly and easily adjusted in size by sliding the connected frames and connecting members, and the structure of the mattress seat body is stable before and after adjustment.

In some implementations, the rack has a rectangular shape, and the mattress seat body includes four frames provided at four edges of the rack and four connecting members provided at four corners of the rack. The mattress seat body employs the most commonly used rectangular rack, which is structurally stable and adaptable to most infant mattresses on the market.

In some implementations, each of the connecting members is slidably disposed with respect to each of the frames correspondingly connected thereto in the circumferential direction of the mattress seat body. The mattress seat body can thereby achieve a greater range of adjustment in size.

In some implementations, the mattress seat body further includes a supporting plate connected to two opposite frames, and the lifting mechanism is connected to the supporting plate. The arrangement of the supporting plate makes a structure of the rack of the mattress seat body more stable.

In some implementations, two of the frames connecting to the supporting plate are disposed relatively movable to each other, and at least one side of the supporting plate and the frame connected thereto are disposed relatively movable to each other. The supporting plate can thus be adjusted in size with the rack.

In some implementations, each side of the supporting plate and the frame connected thereto are relatively movable to each other. Thus, the adjustment of the supporting plate and the rack is more flexible, and the adjustment range of the supporting plate is greater.

In some implementations, the lifting mechanism includes an air bag and a first plate member, the first plate member is provided above the supporting plate, at least one air bag is provided between the first plate member and the supporting plate, and the driving device is configured to control inflation and/or deflation of the air bag. The lifting mechanism is connected to the supporting plate inside the rack of the mattress seat body, and a lifting center of gravity is stable. The lifting mechanism adopts the way of air bag jacking, and a lifting amplitude is gentle and smooth, which can simulate a mother's natural comfort, and help to quickly soothe an infant.

In some implementations, multiple supporting plates and multiple first plate members are respectively provided in a one-to-one correspondence way, and at least one air bag is provided between each of the first plate members and its corresponding supporting plate. The arrangement of the plurality of first plate members and the plurality of supporting plates may further enhance the support stability of the intelligent mattress seat.

In some implementations, a plurality of air bags are provided between the first plate member and its corresponding supporting plate. The plurality of air bags may make a swing amplitude of the first plate member and the mattress above it softer and more variable.

In some implementations, the mattress seat body includes at least two first connecting plates, and the two first connecting plates are slidably connected to each other in a length direction and/or a width direction of the mattress seat body. Size adjustment of the mattress seat body is thereby achieved.

In some implementations, the mattress seat body includes a first connecting plate and a second connecting plate, at least two of the first connecting plates are spaced part from each other, at least one second connecting plate is connected between every two adjacent first connecting plates, and the second connecting plate is slidably disposed with respect to each of the first connecting plates adjacent thereto. A sliding connection of the first connecting plate and the second connecting plate enables a quick and easy adjustment of the mattress seat body in size. In some implementations, the first connecting plates have two connecting plates that are spaced apart on both sides of a first direction of the mattress seat body, the adjacent first connecting plate and second connecting plate are slidably disposed with respect to each other in the first direction of the mattress seat body, and the first direction is a length direction or a width direction of the mattress seat body. The mattress seat body can thus be adjusted in size in at least one direction.

In some implementations, at least one side of each first connecting plate is provided with a third connecting member slidably disposed with respect to the first connecting plate, a sliding direction of the third connecting member with respect to the first connecting plate being perpendicular to a sliding direction of the second connecting plate with respect to the first connecting plate. The arrangement of the third connecting member is configured such that the mattress seat body is adjustable in size in various directions, such as length, width, etc.

In some implementations, at least one side of each second connecting plate is provided with a third connecting member slidable with respect to the second connecting plate, a sliding direction of the third connecting member with respect to the second connecting plate being perpendicular to a sliding direction of the second connecting plate with respect to the first connecting plate. The arrangement of the third connecting member is configured such that the mattress seat body is adjustable in size in various directions, such as length, width, etc.

In some implementations, the lifting mechanism includes a plurality of air bags and a plurality of plate member assemblies, and each of the plate member assemblies includes a second plate member and a third plate member slidably connected to each other; and one of the plate member assemblies is respectively provided above each of the first connecting plates and/or the second connecting plate(s), the air bag is provided between an underneath of each second plate member and a corresponding third connecting member, and/or the air bag is provided between an underneath of each third plate member and a corresponding third connecting member, and the driving device is configured to control inflation and/or deflation of each air bag. The panel assemblies can be adjusted in size with the first connecting plate and/or the second connecting plate to better support mattress of different sizes to which the mattress seat body is adapted such that the mattress is lifted and lowered more smoothly and tenderly.

In some implementations, the lifting mechanism includes a plurality of air bags, and the driving device is configured to control inflation and/or deflation of each of the air bags. The air bag can be used to directly bear the child-bearing apparatus such as mattress, and can also be connected with the supporting plate member, so as to drive the child to swing up and down, and the lifting amplitude is gentle and smooth, which can simulate a natural comfort of a mother and help to quickly soothe the infant.

In some implementations, the driving device is configured to control at least one air bag of the plurality of air bags to be inflated while at least another of the air bags is being inflated. In this way, different air bags are not inflated and deflated simultaneously, and different positions of the lifting mechanism can be raised and lowered, resulting in a soothing effect of natural swinging.

In some implementations, the lifting mechanism includes a supporting plate member, at least one air bag is provided between the supporting plate member and the mattress seat body, and at least a part of the air bag is located below the supporting plate member. The supporting plate member allows for the attachment of different air bags and also provides better support for a child-bearing apparatus such as a mattress.

In some implementations, the supporting plate member includes a second plate member and a third plate member, the second plate member is slidably disposed with respect to the third plate member, the second plate member is connected to at least one air bag, at least a part of the air bag is located below the second plate member; the third plate member is connected to at least one another air bag, and at least a part of the air bag is located below the third plate member. The second plate member and the third plate member are slidably connected to each other to realize the size adjustment of the lifting mechanism, and the air bag can adjust a spacing with the second plate member and the third plate member to ensure smooth support.

In some implementations, the driving device includes an air pump, an electromagnetic valve and an air pipe, one end of the air pipe is in communication with the air bag and the other end of the air pipe is in communication with the air pump, and the air pump is configured to inflate the air bag; and the electromagnetic valve is in communication with the air pump, an exhaust port in communication with an outside is provided on the electromagnetic valve, and the air bag is able to be exhausted through the exhaust port on the electromagnetic valve. The driving device has a simple structure and can achieve rapid inflation or deflation of the air bag.

In some implementations, one end of the air pipe is divided into a plurality of air paths, and the plurality of air paths are in one-to-one communication with a plurality of the air bags. Thus, the plurality of air bags can be simultaneously inflated or deflated, and the whole mattress above can be smoothly lifted and lowered.

In some implementations, the control device controls the driving device to drive the lifting mechanism to reciprocate upwards and downwards with an adjustable amplitude and/or frequency. Thus, a more suitable soothing mode can be selected according to the change of the infant's mood.

In some implementations, the intelligent mattress seat further includes a cry detection device, wherein the cry detection device includes a sound sensor configured to detect a sound and a speech recognition chip configured to recognize a sound; and an output end of the cry detection device is connected to an input end of the control device, and when a loudness of a cry detected by the cry detection device is greater than a pre-set sound loudness threshold value, and/or when a duration of the cry detected by the cry detection device is greater than a pre-set time threshold value, the control device activates the driving device, and the driving device drives the lifting mechanism to reciprocate upwards and downwards.

In some implementations, the control device adjusts an amplitude and/or a frequency of the reciprocation of the lifting mechanism driven by the driving device according to a loudness of a sound detected by the cry detection device. The cry detection device can quickly detect the cry and judge an emotional state of the infant, and automatically set a soothing mode of the intelligent mattress seat by the control device, so that the use of the intelligent mattress seat is more convenient and intelligent, and the burden of parents is reduced.

In some implementations, the intelligent mattress seat further includes at least one sound playing device provided on the mattress seat body, wherein the sound playing device is connected to an output end of the control device, and the control device controls the sound playing device to start playing a sound for soothing a baby when the soundness of the cry detected by the cry detection device is greater than the pre-set sound loudness threshold value. In some implementations, the control device controls a volume of the sound playing device to increase as the loudness of the cry detected by the cry detection device increases. The sound playing device can further assist in the soothing effect of the infant.

In some implementations, the intelligent mattress seat further includes a power reception interface and a power supply interface provided on the mattress seat body, wherein the power reception interface is configured to supply power to the intelligent mattress seat from an external power source; and the power supply interface is configured such that when the intelligent mattress seat is connected to the external power supply, the intelligent mattress seat is able to supply power to an external mobile device via the power supply interface, wherein the intelligent mattress seat includes one or more of power supply interfaces.

In some implementations, the intelligent mattress seat further includes a lighting device provided on the mattress seat body. The arrangement of the power reception interface, the power supply interface and the lighting device makes the function of the intelligent mattress seat more diversified and the use more convenient.

In some implementations, the intelligent mattress seat further includes a control key provided on the mattress seat body, the control key being configured to trigger the control device to perform a corresponding operation if the control device is turned on. Thus, a caretaker can quickly and conveniently select a desired function by operating the control key.

An intelligent mattress seat includes a mattress seat body, and a length of the mattress seat body is adjustable in at least one direction.

An intelligent mattress seat includes a mattress seat body, the intelligent mattress seat further includes a lifting mechanism, the lifting mechanism is connected to the mattress seat body, the lifting mechanism is movable with respect to the mattress seat body, and a length of the lifting mechanism is adjustable in at least one direction.

A children's product includes the intelligent mattress seat according to any one described above and a child-bearing apparatus, the child-bearing apparatus being connected to the lifting mechanism. The children's product may in particular be a cot, a children's sleeping basket, a children's seat or the like, the child-bearing apparatus being intended to directly carry a child lying or sitting.

Some beneficial effects brought about by the technical solutions provided by the embodiments of the present disclosure are as follows:
1) The control device controls the driving device to drive the lifting mechanism to reciprocate upwardly and downwardly and/or swing, and then drives the mattress provided on the lifting mechanism to reciprocate upwards and downwards and/or the swing motion, and an amplitude and a frequency of the motion of the lifting mechanism can be adjusted, so as to effectively soothe the infant and relieve a child-rearing pressure of the user;
2) In the present disclosure, the length of the mattress seat body or the lifting mechanism is adjustable in at least one direction, which can be specifically adjustable in length and width, so as to be able to adapt to mattresses of different sizes and have a long service period; and two kinds of mattress seat bodies with adjustable sizes are specifically provided, wherein the two kinds are mattress seat bodies with an adjustable length and width with a frame, wherein four bed legs can be configured to form an infant bed, while the other kind is mattress seat bodies with an adjustable length and width without a frame, wherein this kind of mattress seat bodies can be used as infant beds by adding frames and bed legs, and can also be used by being placed on infant beds or adult beds, with better versatility;
3) By providing a cry detection device connected to the control device, a signal is sent to the control device when the cry detection device detects an infant cry, the control device controls the driving device to start up, the driving device drives the lifting mechanism to drive the mattress to move, and a soothing mode can be automatically started when the infant cries so as to achieve the purpose of quick soothing, and the lifting amplitude and/or frequency of the lifting mechanism can be automatically adjusted according to the soundness and duration of the infant cry detected by the cry detection device;
4) A sound playing device is configured to play light music and stories, which can not only soothe an infant, but also have an early education function; an input end of the sound playing device is connected to an output end of the control device, which can automatically start playing a soothing music or story when the cry detection device detects an infant cry, and the soothing function thereof is more intelligent;
5) A lighting device is provided on the mattress seat body to play the role of a small night lamp and facilitate a grown-up to observe the state of the infant; and
6) A power supply interface is provided on the mattress seat body and can be used with electronic product accessories such as a camera and a small fan.

### BRIEF DESCRIPTION OF THE DRAWINGS

In order to explain the technical solutions in the embodiments of the present disclosure more clearly, the following contents will briefly introduce the drawings which need to be used in the embodiments. It would be obvious that the drawings in the following description are only some embodiments of the present disclosure, and it is possible for a person skilled in the art to obtain other drawings according to these drawings provided without involving any inventive effort.

FIG. 1 is a schematic diagram from a first angle of a structure of a first type of an intelligent mattress seat according to an embodiment of the present disclosure;

FIG. 2 is a schematic diagram from a second angle of the structure of the first type of the intelligent mattress seat according to an embodiment of the present disclosure;

FIG. 3 is a schematic top view of a small size state of the first type of the intelligent mattress seat according to an embodiment of the present disclosure;

FIG. 4 is a schematic top view of a large size state of the first type of the intelligent mattress seat according to an embodiment of the present disclosure;

FIG. 5 is a schematic diagram of an uninflated structure of the first type of the intelligent mattress seat according to an embodiment of the present disclosure;

FIG. 6 is a schematic diagram of an inflated structure of the first type of the intelligent mattress seat according to an embodiment of the present disclosure;

FIG. 7 is a schematic diagram of a structure of a driving device according to an embodiment of the present disclosure;

FIG. 8 is a schematic diagram of a combination structure of the first type of the intelligent mattress seat and a mattress according to an embodiment of the present disclosure;

FIG. 9 is a schematic diagram of a small size state of a second type of an intelligent mattress seat according to an embodiment of the present disclosure;

FIG. 10 is a schematic diagram of a large size state of a structure of the second type of the intelligent mattress seat according to an embodiment of the present disclosure;

FIG. 11 is a schematic top view of a small size state of the second type of the intelligent mattress seat according to an embodiment of the present disclosure;

FIG. 12 is a schematic top view of a large size state of the structure of the second type of the intelligent mattress seat according to an embodiment of the present disclosure;

FIG. 13 is a schematic diagram of a large size state of the structure of the second type of the intelligent mattress seat without a second plate member and a third plate member according to an embodiment of the present disclosure; and

FIG. 14 is a schematic diagram of a combination structure of the second type of the intelligent mattress seat and a mattress according to an embodiment of the present disclosure;

The reference numerals include: 1—mattress seat body, 11—frame, 12—connecting member, 13—supporting plate, 14—first connecting plate, 15—second connecting plate, 16—third connecting member, 17—fourth connecting member, 18—mounting seat, 2—lifting mechanism, 21—air bag, 22—first plate member, 23—second plate member, 24—third plate member, 3—driving device, 31—air pump, 32—electromagnetic valve, 33—air pipe, 34—box, 4—control device, 5—cry detection device, 6—sound playing device, 7—power supply interface, 8—lighting device, 9—mattress.

### DETAILED DESCRIPTION OF THE INVENTION

In order that a person skilled in the art may better understand the solutions of the present disclosure and more clearly understand the objects, technical solutions and advantages of the present disclosure, a more clear and complete description of the technical solutions of the present disclosure will be rendered by reference to specific embodiments thereof which are illustrated in the appended drawings. It should be noted that implementations not shown or described in the drawings are forms known to a person skilled in the art.

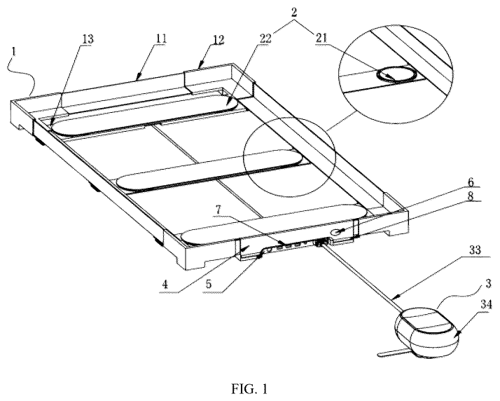

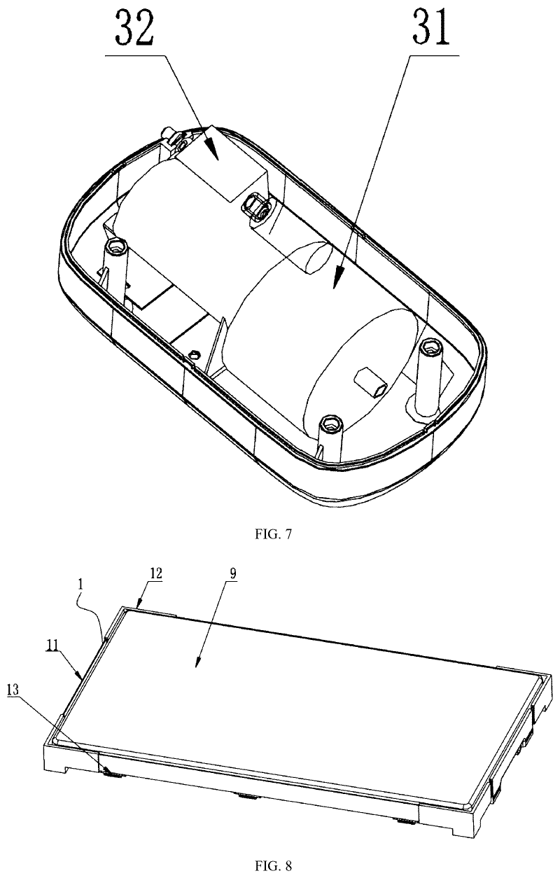

One embodiment of the present disclosure provides an intelligent mattress seat and a children's product including the intelligent mattress seat. With reference to FIGS. 1, 2, 3, 4, 5, 6 and 8, the present intelligent mattress seat includes a mattress seat body 1, a lifting mechanism 2, a driving device 3, a control device 4, a cry detection device 5, a sound playing device 6 and a lighting device 8, etc. In some embodiments, a length of the mattress seat body 1 is adjustable in at least one direction; in still other embodiments, a length of the lifting mechanism 2 is adjustable in at least one direction.

In the present embodiment, the lifting mechanism 2 is connected to the mattress seat body 1, and the driving device 3 is connected to the lifting mechanism 2. The lifting mechanism 2 is specifically provided above the mattress seat body 1, an output end of the control device 4 is electrically connected to an input end of the driving device 3, the control device 4 is configured to activate or inactivate the driving device 3, and when the driving device 3 is activated, the driving device 3 is configured to drive the lifting mechanism 2 to reciprocate upwardly and downwardly, such that the lifting mechanism 2 drives the mattress 9 provided above the lifting mechanism 2 to move; preferably, the control device 4 controls the driving device 3 to drive the lifting mechanism 2 with an adjustable amplitude and frequency of reciprocating lift motion. The user can start a soothing mode of the present intelligent mattress seat when the infant needs to be soothed, namely, the driving device 3 is started via the control device 4 to drive the lifting mechanism 2 to drive the movement of the mattress 9, which effectively relieves the pressure on child rearing of the user, and the frequency and amplitude of the lifting mechanism 2 driving the lifting of the mattress 9 can be adjusted to meet the soothing requirements in different situations.

It should be noted that, within a bearing range of the intelligent mattress seat, in addition to the mattress 9, a parent can also place a child's bed, a sleeping basket, a child seat and other article devices with an infant bearing function on the lifting mechanism according to actual use requirements, such that an infant riding or lying therein can obtain a lifted and soothed experience. Accordingly, the present embodiment provides a children's product including the above-described intelligent mattress seat and a child-bearing apparatus, which may be embodied as a child bed, a child sleeping basket, a child seat or the like, for directly carrying a child to lie or ride.

Further, in the present embodiment, the cry detection device 5 is provided on the mattress seat body 1 and includes a sound sensor configured to detect a sound and a speech recognition chip (including but not limited to a NRK3301 speech recognition chip) configured to recognize a sound. An output end of the cry detection device 5 is connected to an input end of the control device 4, and when the cry detection device 5 detects an infant cry, a corresponding signal is sent to the control device 4, and when the control device 4 receives the signal generated by the cry detection device 5, the driving device 3 is activated, and the driving device 3 drives the lifting mechanism 2 to reciprocate upwardly and downwardly, so as to automatically start the soothing mode when the baby cries so as to achieve the purpose of quick soothing. Alternatively, when the cry detection device 5 detects a cry of the infant and a loudness of the cry is greater than a pre-set sound loudness threshold value, and/or the duration of the cry detected thereby is greater than a pre-set time threshold value, the control device 4 activates the driving device 3, the driving device 3 drives the lifting mechanism 2 to reciprocate upwardly and downwardly, so as to automatically start the soothing mode when the infant cries and to avoid starting the soothing mode when the infant unintentionally cries with one or two sounds. Preferably, the control device 4 adjusts an amplitude and/or a frequency of the reciprocation of the lifting mechanism 2 driven by the driving device 3 according to a loudness of a sound detected by the cry detection device 5. For example, the greater the loudness of a crying signal detected by the cry detection device 5 is, the more severe the infant crying is. The cry detection device 5 sends a corresponding signal to the control device 4 so as to adjust the lifting mechanism 2 to reciprocate upwards and downwards with a relatively large amplitude and/or frequency; conversely, the cry detection device 5 sends another corresponding signal to the control device 4 to adjust the lifting mechanism 2 to reciprocate upwardly and downwardly with a relatively small amplitude and/or frequency.

Further, in the present embodiment, the sound playing device 6 is provided on the mattress seat body 1, which is configured to play music or stories for soothing children, and also has an early education function. Preferably, the sound playing device 6 is connected to an output end of the control device 4, and when the loudness of the cry detected by the cry detection device 5 is greater than a pre-set sound loudness threshold value, the control device 4 controls the sound playing device 6 to start playing music or stories for soothing the baby; conversely, the sound playing device 6 is not automatically activated, and it is possible to avoid activating the sound playing device 6 in the event that the infant unintentionally cries with one or two sounds. Preferably, the control device 4 controls a volume of the sound playing device 6 to increase as the loudness of the cry detected by the cry detection device 5 increases.

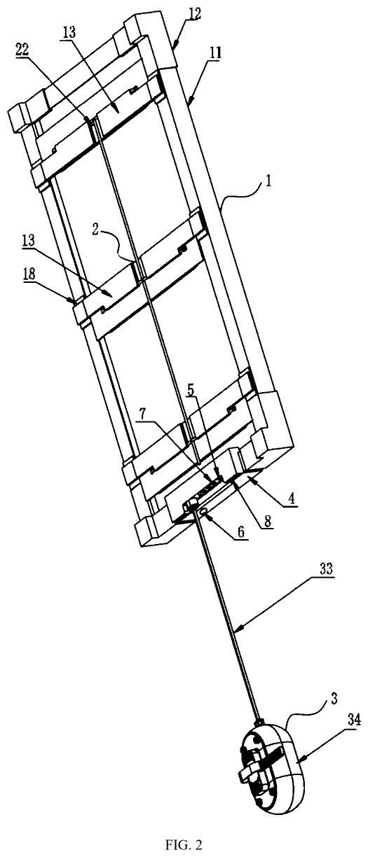

The length of the present intelligent mattress seat is adjustable in size in at least one direction to fit mattresses of different sizes, here in particular the length and width of the mattress seat body 1 are adjustable in size. As shown in FIGS. 1 and 2, the mattress seat body 1 includes a plurality of frames 11, and the plurality of frames 11 are successively provided along a circumferential direction of the mattress seat body 1: of the plurality of frames 11, at least one of the frames 11 is able to be relatively movable with respect to the other frames 11 in the circumferential direction of the mattress seat body 1. Further, the mattress seat body 1 further includes a connecting member 12, and at least two adjacent frames 11 of the plurality of frames 11 are provided with one connecting member 12 in between, wherein at least one frame 11 is slidably disposed with respect to the connecting member 12 in the circumferential direction of the mattress seat body 1. In the present embodiment, the mattress seat body 1 specifically includes a plurality of connecting members 12, wherein every adjacent two frames 11 are connected via one connecting member 12, and the plurality of frames 11 and the plurality of connecting members 12 together enclose a rack of the mattress seat body 1. Of the plurality of connecting members 12, there are at least two adjustable connecting members 12, and each adjustable connecting member 12 is slidably connected to at least one frame 11 correspondingly connected thereto in the circumferential direction of the mattress seat body 1. In the present embodiment, the rack of the above-mentioned mattress seat body 1 has a rectangular shape, and the mattress seat body 1 includes four frames 11 provided at four sides of the frame, and four connecting members 12 provided at four corners of the rack. Each of the connecting members 12 is slidably disposed with respect to each of the frames 11 correspondingly connected thereto in the circumferential direction of the mattress seat body 1 such that the length and width of the intelligent mattress seat can be adjusted in size to fit mattress of different sizes. In other embodiments, the connecting member 12 may not be provided between adjacent frames 11, and a structure such as a sliding rail, a telescopic rod or the like may be directly used to achieve a sliding connection between movable frames 11. In the present embodiment, the mattress seat body 1 further includes a supporting plate 13, the supporting plate 13 is connected to two opposite frames 11, and at least one side of the supporting plate 13 is slidably provided with respect to the frames 11 connected thereto. Preferably, each side of the supporting plate 13 is slidably provided with respect to the frame 11 connected thereto, and the supporting plate 13 is connected to two frames 11 in a length direction of the intelligent mattress seat, namely, the supporting plate 13 is provided parallel to a width direction of the mattress seat body 1. The lifting mechanism 2 is connected to the supporting plate 13, and is specifically provided above the supporting plate 13.

In other embodiments, the shape of the mattress seat body 1 is also not limited to a rectangle, for example, it can be a circle, a polygon or an irregular shape, etc., in which case the mattress seat body 1 may not have a strict length and width direction, but, on the basis of the idea of the present disclosure, for example, a plurality of frames 11 which are slidably connected to each other may be provided, enabling the size adjustment of the mattress seat body 1 to fit child-bearing apparatuses of different sizes.

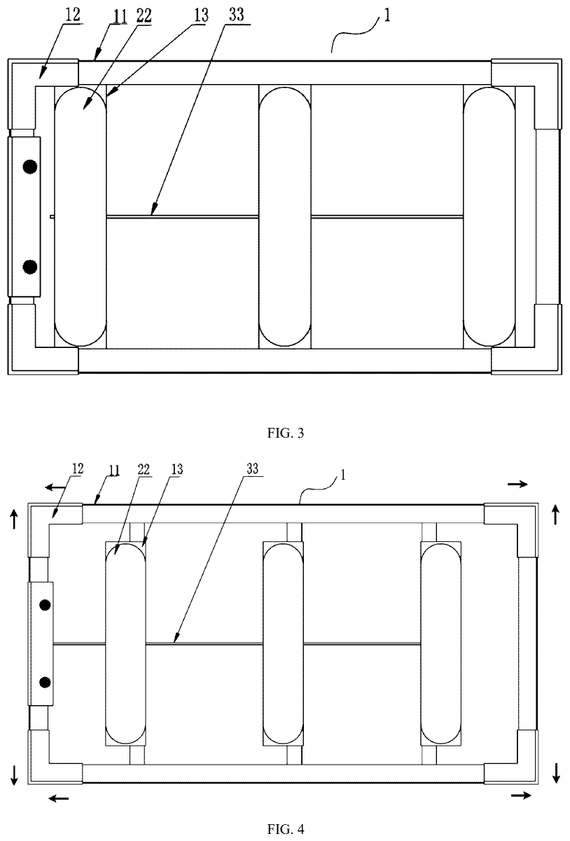

In a specific embodiment of the present disclosure, two ends of each of the frames 11 are slidably provided in two of the connecting members 12 correspondingly connected thereto, and by sliding the connecting member 12 in an extension direction (see the arrow direction in FIG. 4) of the corresponding frame 11, the size of the intelligent mattress seat can be adjusted to be larger so as to accommodate a mattress with a large size; conversely, by sliding the connecting member 12 in a middle direction of the corresponding frame 11, the size of the intelligent mattress seat can be adjusted to be smaller, with reference to FIG. 3, so as to accommodate a mattress with a small size. It should be noted that the present disclosure is not limited to the present embodiment. For example, two of the connecting members 12 located on one diagonal line of the intelligent mattress seat are fixedly connected to corresponding connecting members 12, and two of the connecting members 12 located on the other diagonal line of the intelligent mattress seat are slidably connected to corresponding connecting members 12, such that it is also possible to adjust the size of the intelligent mattress seat, which should be considered as a simple alternative to the present embodiment. Accordingly, at least one end of the supporting plate 13 is slidably connected to the corresponding frame 11, and, with reference to FIG. 2, several mounting seats 18 are correspondingly provided at bottoms of the two opposite frames 11; the mattress seat body 1 includes a plurality of supporting plates 13, and two ends of each the supporting plate 13 are respectively slidably provided in one mounting seat 18; and during a relative sliding of the frame 11 and the connecting member 12, the supporting plate 13 can also correspondingly slide with respect to the mounting seat 18, so as to meet the requirement of adjusting the size of the intelligent mattress seat. In the present embodiment, the use of an infant bed is made possible by providing a bed leg below four of the connecting members 12. In addition, the present intelligent mattress seat can adapt to most infant mattresses on the market, can extend a life cycle of the infant bed, can save the cost of nursing for the user and can avoid waste of resources.

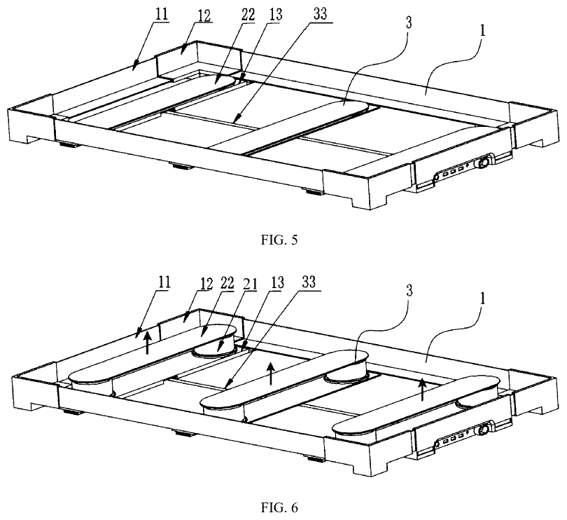

With reference to FIG. 6, the lifting mechanism 2 includes a plurality of air bags 21, and the driving device 3 is configured to control inflation and/or deflation of each of the air bags 21. In the present embodiment, the lifting mechanism 2 further includes a supporting plate member capable of supporting an infant-bearing apparatus such as a mattress, wherein at least one air bag 21 is provided between the supporting plate member and the mattress seat body 1, and at least a part of the air bag 21 is located below the supporting plate member, where the supporting plate member is integrally provided at a top of the air bag 21. In this way, when the air bag 21 is inflated, a corresponding position of the supporting plate member can be lifted up; when the air bag 21 is deflated, the supporting plate member in this position is relatively lowered. In the present embodiment, the supporting plate member is specifically a first plate member 22, the first plate members 22 and the air bags 21 are respectively provided in a plurality, multiple first plate members 22 and multiple supporting plates 13 are respectively provided in a one-to-one correspondence way, the first plate members 22 are provided above its corresponding supporting plates 13, and at least one air bag 21 is provided between each first plate member 22 and its corresponding supporting plate 13. Preferably, a plurality of air bags 21 are provided between each first plate member 22 and its corresponding supporting plate 13, where two air bags 21 are specifically provided between each first plate member 22 and its corresponding supporting plate 13, and the two air bags 21 are symmetrically provided along the length direction of the supporting plate 13.

With reference to FIG. 7, the driving device 3 includes an air pump 31, an electromagnetic valve 32, an air pipe 33 and a box 34, wherein the air pump 31 and electromagnetic valve 32 are provided inside the box 34, one end of the air pipe 33 is divided into a plurality of air paths and is in communication with a plurality of air bags 21, and the other end of the air pipe 33 passes through the box 34 and is in communication with the air pump 31, and the air pump 31 is configured to inflate the air bag 21; the electromagnetic valve 32 communicates with the air pump 31, and an exhaust port communicating with an outside is provided on the electromagnetic valve 32, and the air bag 21 can be deflated through the exhaust port on the electromagnetic valve 32. When the driving device 3 is opened and operated, the air pump 31 and the electromagnetic valve 32 alternately inflate and deflate the air bag 21, and during inflation, the electromagnetic valve 32 is closed, and the air pump 31 inflates the air bag 21 via the air pipe 33, such that an volume of the air bag 21 expands and rises, and then drives the first plate member 22 and the mattress provided above to rise, as shown in FIG. 6; during deflation, the electromagnetic valve 32 is opened, the air pump 31 stops inflating, and the air in the air bag 21 is discharged through the exhaust port of the electromagnetic valve 32 by the gravity of the mattress and the plate member 22, thereby lowering the mattress and returning to the state shown in FIG. 5. The driving device 3 has an operating mode and a stopping operation mode, and when the driving device 3 starts the operating mode, the lifting mechanism 2 is driven to drive the mattress to move so as to achieve soothing of an infant; when the driving device 3 stops operation, the soothing mode that drives the movement of the mattress is not turned on. Alternatively, the driving device 3 or the control device 4 may be switched off to switch the intelligent mattress seat to normal mattress seat mode. In some implementations, the driving device 3 may be used only to control the inflation of the air bag 21 and in combination with other mechanisms to effect deflation of the air bag 21; conversely, in other implementations, the driving device 3 may be used only to control the deflation of the air bag 21, and in combination with other mechanisms to effect the inflation of the air bag 21.

In some implementations, the driving device 3 is used to control at least one air bag 21 of the plurality of air bags 21 to be inflated while another air bag 21 is being deflated; alternatively, the driving device 3 controls different air bags 21 to have different inflation and deflation schedules, and the plurality of air bags 21 are not completely simultaneously inflated and deflated. For example, when the air bag 21 on one side in the width direction of the supporting plate member is gradually inflated, the air bag 21 on the other side is gradually deflated, such that the supporting plate member is inclined to one side; as time changes, when the air bag 21 on one side of the supporting plate member in the width direction is gradually deflated, the air bag 21 on the other side thereof is gradually inflated; this reciprocation achieves the effect that the supporting plate member moves up and down while swaying, such that the child can obtain a more varied soothing.

In the present embodiment, the lighting device 8 is provided on the mattress seat body 1, and the lighting device 8 may be embodied as a light strip capable of functioning as a small night light to facilitate an observation of a state of the infant by a grown-up. Preferably, the light strip 8 is provided at a position lower than a height of the mattress without affecting the infant. In the present embodiment, the intelligent mattress seat further includes a power reception interface (not shown in the figure) provided on the mattress seat body 1 and a power supply interface 7, wherein the power reception interface is configured to supply the multifunctional mattress from an external power source; the power supply interface 7 (including but not limited to USB interface/Type-C interface) is configured such that when the multifunctional mattress is connected to an external power source, the multifunctional mattress can power an external mobile device (such as small fans, electric bells, etc.) through the power supply interface 7, wherein the intelligent mattress seat includes one or more of power interfaces 7.

In the present embodiment, the intelligent mattress seat further includes several control keys (not shown in the figure) provided on the mattress seat body 1, and may specifically include control keys used for controlling on or off of one or more of the driving device 3, the control device 4, the cry detection device 5, the sound playing device 6 and the lighting device 8; and the intelligent mattress seat may further include a control key for triggering the control device 4 to perform a corresponding operation in the case where the control device 4 is turned on, the corresponding operation including, but being not limited to, activating the driving device 3, and controlling the amplitude and/or frequency at which the driving device 3 drives the lifting mechanism 2 to reciprocate upwards and downwards. It should be noted that the control keys may specifically be physical mechanical keys or screen touch keys, etc. and the present disclosure is not limited thereto.

Preferably, with reference to FIG. 1, a multifunctional control box is provided at a position (e.g. one side) where it is convenient for a user to operate the intelligent mattress seat, the control device 4, the cry detection device 5, the sound playing device 6 and a power module of the lighting device 8 are provided inside the multifunctional control box, and a lamp tube/bulb of the lighting device 8 is provided at one side or a bottom of the multifunctional control box; and the multifunctional control box is provided with a sound outlet hole for the sound playing device 6 to conduct sound and an interface for the control device 4 to be connected to the driving device 3. A remote switch may also be provided for controlling the intelligent mattress seat. In the present embodiment, there is provided another size-adjustable mattress seat body 1 and a lifting mechanism 20 capable of adjusting a size thereof together with the mattress seat body 1.

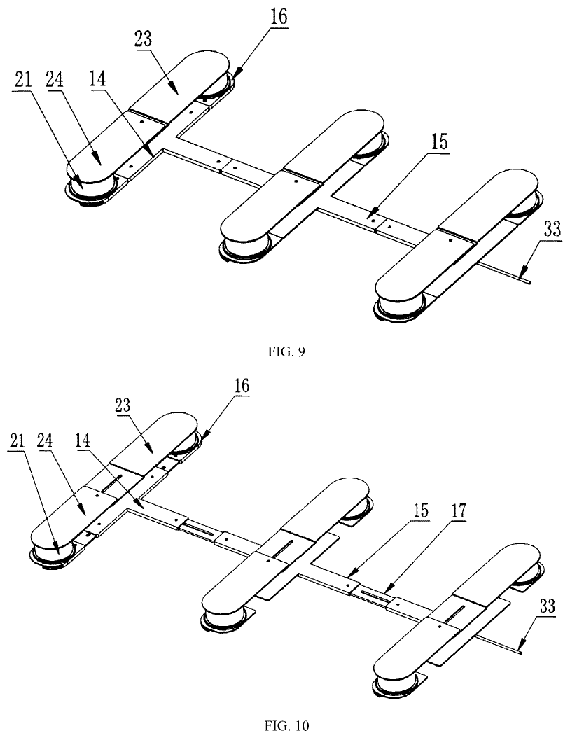

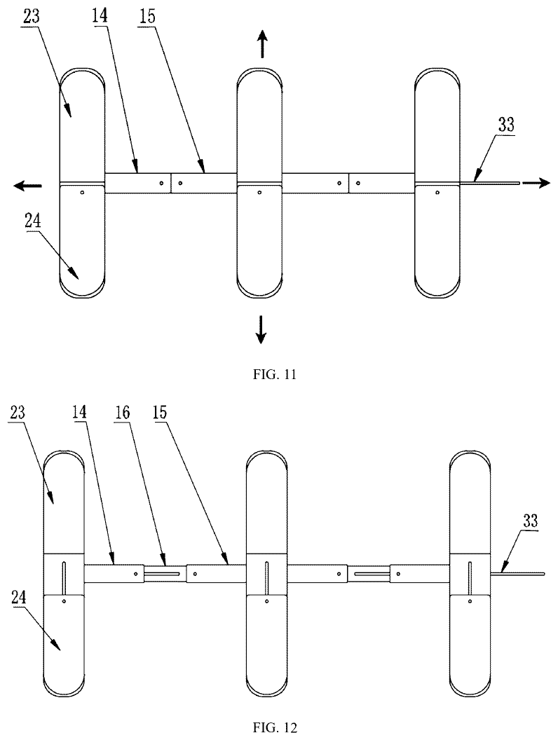

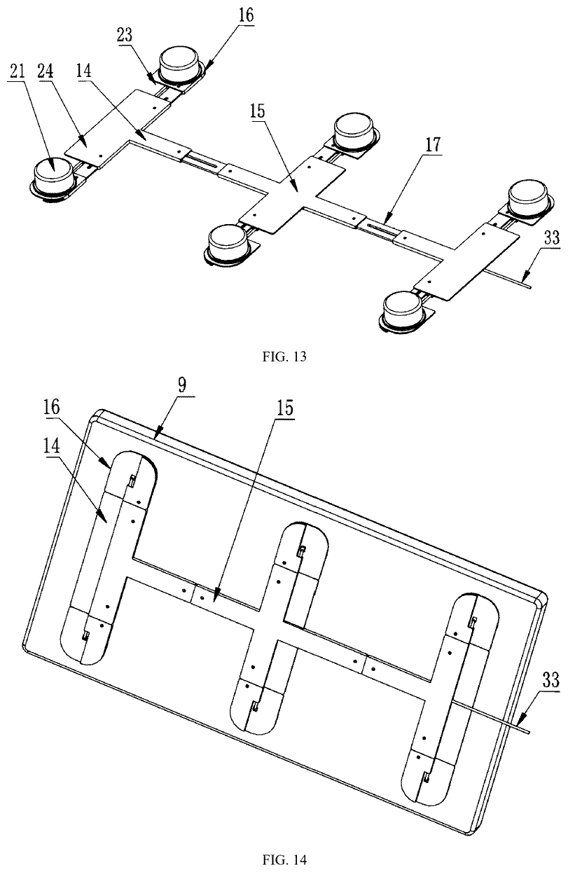

In the present embodiment, referring to FIGS. 9, 10, 11, 12, 13 and 14, the mattress seat body 1 includes at least two first connecting plates 14, and two first connecting plates 14 are slidably connected to each other in a length direction and/or a width direction of the mattress seat body 1, thereby achieving the size adjustment of the mattress seat body 1.

In the present embodiment, the mattress seat body 1 further includes a second connecting plate 15, at least two of the first connecting plates 14 are spaced part from each other, at least one second connecting plate 15 is connected between every two adjacent first connecting plates 14, and the second connecting plate 15 is slidably disposed with respect to each of the first connecting plates 14 adjacent thereto. Further, the first connecting plates 14 have two connecting plates 14 that are spaced apart on both sides of a first direction of the mattress seat body 1, the adjacent first connecting plate 14 and second connecting plate 15 are slidably disposed with respect to each other in the first direction, and the first direction is a length direction or a width direction of the mattress seat body 1. In the present embodiment, the mattress seat body 1 specifically includes first connecting plates 14 provided at two ends of a length of the mattress seat body, one second connecting plate 15 is provided between the two first connecting plates 14, and adjacent first connecting plates 14 and the second connecting plates 15 are slidably connected to each other along the length direction of the mattress seat body 1. Each of the first connecting plates 14 is respectively provided with one third connecting member 16 at each of both sides along the width direction of the mattress seat body 1, and the third connecting member 16 and the first connecting plate 14 are slidably provided along the width direction of the mattress seat body 1; each of the second connecting plate(s) 15 is respectively provided with one second connecting plate 15 at each of both sides along the width direction of the mattress seat body 1, and the third connecting member 16 and the second connecting plate 15 are slidably provided in the width direction of the mattress seat body 1. With reference to FIG. 10, when the first connecting plate 14 slides to both ends of the second connecting plate 15 with respect to a middle thereof, the size in the length direction is increased, and when the third connecting member 16 slides to both ends with respect to the first connecting plate 14 and the second connecting plate 15, the size in the width direction is increased. Specifically, as shown in FIG. 10, a fourth connecting member 17 is provided between the first connecting plate 14 and the second connecting plate 15, the fourth connecting member 17 is provided with a first sliding groove, and a first sliding block (not shown in the figure) capable of sliding in the first sliding groove is provided on the first connecting plate 14 or the second connecting plate 15. In other embodiments, the relative sliding of the first connecting plate 14 and the second connecting plate 15 can also be achieved by correspondingly providing a sliding rail and a sliding seat on the first connecting plate 14 and the second connecting plate 15, and the present disclosure does not limit the specific implementation of the relative sliding of the first connecting plate 14 and the second connecting plate 15. The intelligent mattress seat has no frame and has a more compact structure, which can be used either by adding a frame and a bed leg to become a infant bed, or can be placed on an infant bed or an adult bed with better versatility.

Further, in the present embodiment, the lifting mechanism 2 includes a plurality of air bags 21 and a plurality of plate member assemblies, wherein the plate member assemblies are the supporting plate members in the lifting mechanism 2, and each of the plate member assemblies includes a second plate member 23 and a third plate member 24 slidably connected to each other; and one of the plate member assemblies is respectively provided above each of the first connecting plates 14 and/or the second connecting plate(s) 15, the air bag 21 is provided between an underneath of each second plate member 23 and a corresponding third connecting member 16, and/or the air bag 21 is provided between an underneath of each third plate member 24 and a corresponding third connecting member 16, and the driving device 3 is configured to control inflation and/or deflation of each air bag 21. In the present embodiment, one air bag 21 is provided below each of the second plate member 23 and the third plate member 24, respectively, and one air bag 21 is provided above each of the third connecting member(s) 16, respectively, such that each plate member assembly can be slidably adjusted along with the first connecting plate 14, the second connecting plate 15 and the third connecting member 16, and a gentle lift motion can be achieved by inflating and deflating the air bag 21.

It should be noted that two or more second connecting plates 15 may also be provided between the two first connecting plates 14, and the present intelligent mattress seat can be adjusted in size only by slidably connecting adjacent first connecting plate 14 and second connecting plate 15 and/or two adjacent second connecting plates 15 along the length direction of the mattress seat body 1. It should be seen as a simple alternative to the present embodiment.

In some embodiments, the lifting mechanism 2 also includes the above-mentioned plate member assembly and a plurality of air bags 21, wherein the plate member assembly includes a second plate member 23 and a third plate member 24 which are slidably connected to each other, the second plate member 23 is connected to at least one air bag 21, and at least a part of the air bag 21 is located below the second plate member 23; the third plate member 24 is connected to at least one another air bag 21, at least a part of the air bag 21 is located below the third plate member 24, the driving device 3 being configured to control inflation and/or deflation of each air bag 21. In the present embodiment, the lifting mechanism 2 itself can achieve the size adjustment in the length and/or width direction of the intelligent mattress seat; the mattress seat body 1 can adopt either the adjustable structure described above or other non-adjustable structures; at this time, the mattress seat body 1 merely serves to support and fix the lifting mechanism 2; and movable structures such as a sliding rail and a sliding groove can be provided between each air bag 21 and the mattress seat body 1, such that the distance between different air bags 21 can be adjusted.

Further, in some implementations, only one set of the above-mentioned plate member assembly may be provided in the lifting mechanism 2, and the second plate member 23 and the third plate member 24 respectively have sufficient supporting areas to support the whole mattress or the like; in still other embodiments, multiple sets of the above-described plate member assemblies may be provided in the lifting mechanism 2 for supporting the mattress or the like together, and there may be no connection between the different plate member assemblies, or there can be a connection through one or more plate members to further enhance a support strength of the plate member assembly.

It should be noted that, similar to the mattress seat body 1, the specific arrangement of the supporting plates in the lifting mechanism 2 is not limited to the “ [symbol] ”-shaped, “ [symbol] ”-shaped, etc. shown in the drawings, but in some embodiments the supporting plate member may also be provided with a circular, polygonal, irregular shape, etc., in which case the lifting mechanism 2 may not have strict length and width directions, but, on the basis of the concept of the present disclosure, for example, the provision of the second plate member 23 and the third plate member 24, which are slidably connected to each other, can also enable size adjustment in at least one direction of the lifting mechanism 2 to adapt to child-bearing apparatuses of different sizes.

The above-mentioned description is merely a preferred embodiment of the present disclosure, and does not limit the scope of patent of the present disclosure. Any equivalent structural transformation or equivalent process transformation made by using the contents of the description and the drawings of the present disclosure or direct or indirect use in a relevant technical field is likewise included in the scope of the patent protection of the present disclosure.

1-36. (canceled)

37. A mattress seat comprising a mattress seat body configured to receive a mattress thereon, the mattress seat body comprising a plurality of frames disposed sequentially in a circumferential direction of the mattress seat body, at least one of the plurality of frames is movable with respect to the other one of the plurality of frames in the circumferential direction of the mattress seat body to enable a length of the mattress seat body to be adjusted in at least one direction.

38. The mattress seat according to claim 37, wherein at least two adjacent frames of the plurality of frames are provided with a connecting member in between, at least one frame is slidably connected with the connecting member in the circumferential direction of the mattress seat body.

39. The mattress seat according to claim 38, wherein the mattress seat further comprises a lifting mechanism connected to the mattress seat body, a driving device connected to the lifting mechanism and a control device, an output end of the control device is electrically connected to an input end of the driving device, the control device is configured to activate or inactivate the driving device, when the driving device is activated, the driving device is configured to drive the lifting mechanism to reciprocate upwards and downwards and/or swing.

40. The mattress seat according to claim 39, wherein the mattress seat body further comprises a supporting plate connected to the lifting mechanism, the supporting plate is movably connected to two frames on opposite sides of the mattress seat.

41. The mattress seat according to claim 39, wherein the lifting mechanism comprises an air bag and a first plate member, the first plate member is provided above the supporting plate, at least one air bag is provided between the first plate member and the supporting plate, and the driving device is configured to control inflation and/or deflation of each air bag.

42. The mattress seat according to claim 39, wherein the mattress seat body comprising a first connecting plate and a second connecting plate, at least two of the first connecting plates are spaced apart from each other, at least one second connecting plate is provided between every two adjacent first connecting plates, and the second connecting plate is slidably disposed with respect to each of the first connecting plates adjacent thereto.

43. The mattress seat according to claim 42, wherein two connecting plates are spaced apart on both sides of a length direction or a width direction of the mattress seat body, adjacent first connecting plate and the second connecting plate are slidably disposed with respect to each other in the length direction or a width direction of the mattress seat body.

44. The mattress seat according to claim 42, wherein at least one side of each first connecting plate is provided with a third connecting member slidably disposed with respect to the first connecting plate, a sliding direction of the third connecting member with respect to the first connecting plate is perpendicular to a sliding direction of the second connecting plate with respect to the first connecting plate.

45. The mattress seat according to claim 44, wherein the lifting mechanism comprises a plurality of air bags and a plurality of plate member assemblies, each of the plate member assemblies comprising a second plate member and a third plate member slidably connected to each other;
and one of the plate member assemblies is respectively provided above each of the first connecting plates and/or each of the second connecting plates, the air bag is provided between an underneath of each second plate member and the corresponding third connecting member, and/or the air bag is provided between an underneath of each of the third plate member and the corresponding third connecting member, and the driving device is configured to control inflation and/or deflation of each air bag.

46. The mattress seat according to claim 39, wherein the control device controls the driving device to drive the lifting mechanism to reciprocate upwards and downwards with an adjustable amplitude and/or frequency.

47. The mattress seat according to claim 39, further comprising a cry detection device, wherein the cry detection device comprises a sound sensor configured to detect a sound and a speech recognition chip configured to recognize a sound; an output end of the cry detection device is connected to an input end of the control device, and when a loudness of a cry detected by the cry detection device is greater than a pre-set sound loudness threshold value, and/or when a duration of the cry detected by the cry detection device is greater than a pre-set time threshold value, the control device activates the driving device, and the driving device drives the lifting mechanism to reciprocate upwards and downwards.

48. The mattress seat according to claim 47, wherein the control device adjusts an amplitude and/or a frequency of the reciprocation of the lifting mechanism driven by the driving device according to a loudness of a sound detected by the cry detection device.

49. The mattress seat according to claim 39, further comprising at least one sound playing device provided on the mattress seat body, wherein the sound playing device is connected to an output end of the control device, when the soundness of the cry detected by the cry detection device is greater than the pre-set sound loudness threshold value, the control device controls the sound playing device to start playing a sound for soothing a baby.

50. The mattress seat according to claim 49, wherein the control device controls a volume of the sound playing device to increase as the loudness of the cry detected by the cry detection device increases.
